(19) United States
(12) Patent Application Publication
(10) Pub. No.: US 2018/0274292 A1
(43) Pub. Date: Sep. 27, 2018

(54) Solar Radiation Reflective and Infrared Radiation Emissive and Reflective Window Blinds

(71) Applicants: David R. Hall, Provo, UT (US); Emily Brimhall, Alpine, UT (US); Austin Carlson, Provo, UT (US); Jennifer Stevens, Provo, UT (US); Terrece Pearman, Draper, UT (US)

(72) Inventors: David R. Hall, Provo, UT (US); Emily Brimhall, Alpine, UT (US); Austin Carlson, Provo, UT (US); Jennifer Stevens, Provo, UT (US); Terrece Pearman, Draper, UT (US)

(21) Appl. No.: 15/465,813

(22) Filed: Mar. 22, 2017

(51) Int. Cl. E06B 9/386; E06B 9/28; G02B 5/08; B32B 27/06

(52) U.S. Cl. CPC E06B 9/386; E06B 9/28; E06B 2009/2429; B32B 27/06; G02B 5/08

(57) ABSTRACT

We disclose a window blind which includes a metamaterial film on the slats. The metamaterial film reflects solar irradiance and is infrared emissive. The metamaterial fabric may contain silicon dioxide microspheres embedded in a polymer and the polymer may be coated with a silver coating. The long edges of the slats of the blinds may be attached to a sheet of substantially transparent infrared reflective optical interference film. When the slats of the blinds are open, the infrared reflective optical interference film may reflect infrared radiation thus preventing it from passing into the adjacent room while still permitting light to enter the room. The metamaterial film may inhibit both solar and infrared radiation from heating the adjacent room. Consequently, the disclosed window blinds promote radiative cooling instead of impeding heat transmission into an adjacent room.

### BACKGROUND

### Field of the Invention

This disclosure relates to window blinds, specifically window blinds which reflect solar energy for purposes of cooling.

### Background of the Invention

In certain climates, the energy required to cool a building can comprise a substantial portion of a building's utility bill. A large portion of the cooling required is the result of thermal heating of a building. Windows and glass doors, in particular, allow a substantial amount of radiation into a building. Window coatings or other treatments have been developed to inhibit the transmission of solar radiation into an adjacent room. In addition, some windows are built to be double or triple paned or to have an insulative later to insulate the building from the outside environment. However, these treatments are not easily removable. Since these solutions can only prevent solar heating, they are of less value in environments where it is desirable to prevent solar heating during some seasons and to utilize solar heating during other seasons.

Technology has been developed which allows for daytime passive radiative cooling by use of a metamaterial film. The metamaterial film reflects solar irradiance while simultaneously emitting infrared radiation of the wavelengths of the infrared transparency window of the atmosphere. This material has been proposed for use on roofs and potentially even for walls of buildings, due to the silver backing it is opaque. Consequently, it cannot be used directly on windows.

Infrared reflective optical interference film that is also substantially transparent to visible light has also been developed. Although windows typically absorb or reflect thermal infrared radiation, glass transmits most near infrared radiation. Near infrared radiation can contribute to the warming of an adjacent room through a window. While this material can be used directly on windows because it is transparent to visible light, it is only capable of preventing the transmission of near infrared radiation and is not removable. In addition, it has no ability to cool the adjacent materials.

A window treatment is needed which will allow a synthesis of these multiple technologies to assist in adjustably cooling a home without using any external energy.

### BRIEF SUMMARY OF THE INVENTION

We disclose a window blind that may mitigate the effects of solar heating and simultaneously passively cool the blinds through radiation without using any external energy by utilizing multiple materials with different optical properties. The window blind may have slats which may be covered with a metamaterial film. The metamaterial film may be a polymer with silicon dioxide (SiO₂) microspheres incorporated into it. It may also include a sheet of silver to which the polymer may be attached. The metamaterial film may induce radiative cooling through a combination of two properties. The metamaterial film may be substantially reflective of solar irradiance while also emitting strongly in the infrared wavelengths that correspond to the infrared transparency window of the atmosphere. Consequently, the metamaterial film may achieve daytime passive radiative cooling, which may allow the window blinds to contribute to cooling the rest of the building.

The metamaterial film may be attached to the top, bottom, or both surfaces of each slat, depending on the embodiment of the invention. This may allow the user to choose whether radiative cooling is desired. In some embodiments of the invention, the slats may be made of or include a thermally non-conductive material.

In addition to the passive radiative cooling described, the disclosed invention may also decrease the amount of solar radiation that may pass through the slats when they are open. The disclosed window blind may also include at least one sheet of infrared reflective optical interference film. The infrared reflective optical interference film may be substantially transparent to wavelengths of light in the visible spectrum but substantially reflective of infrared radiation. Consequently, the infrared radiation that may heat up a room adjacent to a window blind may be substantially blocked while not inhibiting a user's view through the window blind. In some embodiments, the infrared reflective optical interference film may be attached to the front longitudinal edges of each slat. In other embodiments, the infrared reflective optical interference film may be attached to the back longitudinal edges of each slat. In some embodiments, the infrared reflective optical interference film may be a single sheet which is attached to each of the slats. In other embodiments, the infrared reflective optical interference film may be several sheets, each of which may attach on the longitudinal edges of slats which may be adjacent to each other. The infrared reflective optical interference film may be substantially flexible or incorporated onto a material that is substantially flexible.

### BRIEF DESCRIPTION OF THE DRAWINGS

FIG. 1A is a schematic drawing of an embodiment of a slat of a window blind according to the disclosure.

FIG. 1B is a view from the transverse edge of the slat of FIG. 1A.

FIG. 2A is a schematic drawing of an embodiment of a window blind according to the disclosure with the infrared reflective optical interference film attached to the back longitudinal edge of the slats.

FIG. 2B is a view from the transverse edge of the window blind of FIG. 2A.

FIG. 2C is a view from the transverse edge of the window blind of FIG. 2A with the slats closed.

FIG. 3A is a schematic drawing of an embodiment of a window blind according to the disclosure with the infrared reflective optical interference film attached to the front longitudinal edge of the slats.

FIG. 3B is a view from the transverse edge of the window blind of FIG. 3A.

FIG. 3C is a view from the transverse edge of the window blind of FIG. 3A with the slats closed.

### DETAILED DESCRIPTION OF THE INVENTION

### Definitions

Window blind, as used herein, means a blind that covers an opening in a building, including a window or door.

While this invention is susceptible of embodiment in many different forms, there are shown in the drawings, which will herein be described in detail, several specific embodiments with the understanding that the present disclosure is to be considered as an exemplification of the principals of the invention and is not intended to limit the invention to the illustrated embodiments.

We disclose a window blind that may mitigate the effects of solar heating and simultaneously passively cool the blinds through radiation without using any external energy.

Radiative cooling occurs as an object emits blackbody radiation through the infrared transparency window of the atmosphere into outer space. This is known to be very effective and has been used in multiple applications to achieve passive cooling at nighttime. However, during the day the effects of solar irradiance negate the cooling gains of radiative cooling. A metamaterial film has been developed that reflects solar irradiance while simultaneously emitting strongly in the infrared wavelengths that correspond to the infrared transparency window. One example of a film with these properties is described in Y. Zhai, et al., Scalable-manufactured randomized glass-polymer hybrid metamaterial for daytime radiative cooling. Science 355, 1062-1066 (2017) which is hereby incorporated by reference in its entirety. The current disclosure uses the described metamaterial film to achieve daytime passive radiative cooling, which may allow the window blinds to contribute to cooling the rest of the building. To enhance the effectiveness of the metamaterial film, the window blind may be used outside of the window as well as inside the building.

The window blind may include a plurality of slats, each of which may have a front and back longitudinal edge, two transverse edges, and a top and bottom surface. In some embodiments, the metamaterial film may be attached to a top surface of each of the slats. In some embodiments, the metamaterial film may additionally or alternatively be attached to the bottom surface of each of the slats. In the embodiments in which the film is attached to only one surface, it may be desirable to be able reverse the direction in which the blinds close such that the surface with the metamaterial film may either be substantially exposed to the atmosphere or substantially hidden from the atmosphere. This may be useful in climates in which radiative cooling is not desired year-round. In some embodiments, the slats themselves may be removable such that the position of the metamaterial may be switched to enhance this effect. In another embodiment, the slats may be vertical, which may make it easier to reverse the orientation of the slats.

The metamaterial film may be a polymeric film between 25 and 75 micrometers thick. The metamaterial film may be constructed of one or more of the following: polymethylpentene, poly(methyl methacrylate), and polyethylene. The polymeric film may contain silicon dioxide microspheres (SiO₂). The microspheres may be incorporated into the polymeric film at a concentration of between approximately 4% and 8% by volume. The metamaterial may also include a silver coating between the polymer and the adjacent surface of each slat. The silver coating may be between about 100 nm and 300 nm thick. The combination of the polymeric film with the microspheres incorporated therein and the silver coating may allow the metamaterial to reflect solar irradiation and strongly emit infrared radiation corresponding to the infrared transparency window of the atmosphere.

In some embodiments of the invention, the slat may be made of or include a thermally non-conductive material. The thermally-nonconductive material may prevent the slats from transmitting thermal energy from the slat to the window glass, particularly when the blind is used outside the building. The thermally non-conductive material may be one or more of the following: silicone rubber, fiberglass, foam-glass, polyurethane foam, expanded polystyrene, acrylic glass, and Teflon.

When the slats of a window blind are open, the solar radiation that passes through the spaces between the slats may still considerably heat up a room adjacent to the window blind. To further reduce solar heating, the disclosed invention may also include at least one sheet of infrared reflective optical interference film which may be attached to a longitudinal edge of each of the slats. In some embodiments, the infrared reflective optical interference film may be attached to a back longitudinal edge of each of the slats. In other embodiments, the infrared reflective optical interference film may be attached to a front longitudinal edge of each of the slats.

The infrared reflective optical interference film may be substantially transparent to wavelengths of light in the visible spectrum while reflecting infrared radiation. As it may be mostly transparent to visible light, a user's view from the window may not be substantially inhibited by this film on the window blind. The infrared reflective optical interference film may be a multilayer film which may be that disclosed in U.S. Pat. No. RE 34,605 filed Dec. 11, 1992, a reissue of U.S. Pat. No. 5,103,337, which is hereby incorporated by reference in its entirety. The infrared reflective optical interference film may be substantially flexible or incorporated onto a material that is substantially flexible.

In some embodiments of the invention, the infrared reflective optical interference film may be a single sheet. In this embodiment, the sheet may be attached to the back or front longitudinal edge of each of the slats at varying points on the sheet. In other embodiments, the window blind may include a plurality of sheets of infrared reflective optical interference film. In one such embodiment, a first longitudinal edge of a first sheet of the infrared reflective optical interference film may be attached to the back longitudinal edge of a first slat of the disclosed window blind. Then, a second longitudinal edge of the first infrared reflective optical interference sheet may be attached to a back longitudinal edge of a second slat. In some embodiments, the first slat may be adjacent to the second slat.

In some embodiments, the infrared reflective optical interference film may be removable, which may be desirable when cleaning of the window blind is needed. In addition, it may be desirable in climates where thermal heating from the sun is desirable during the day to reduce the cost of heating.

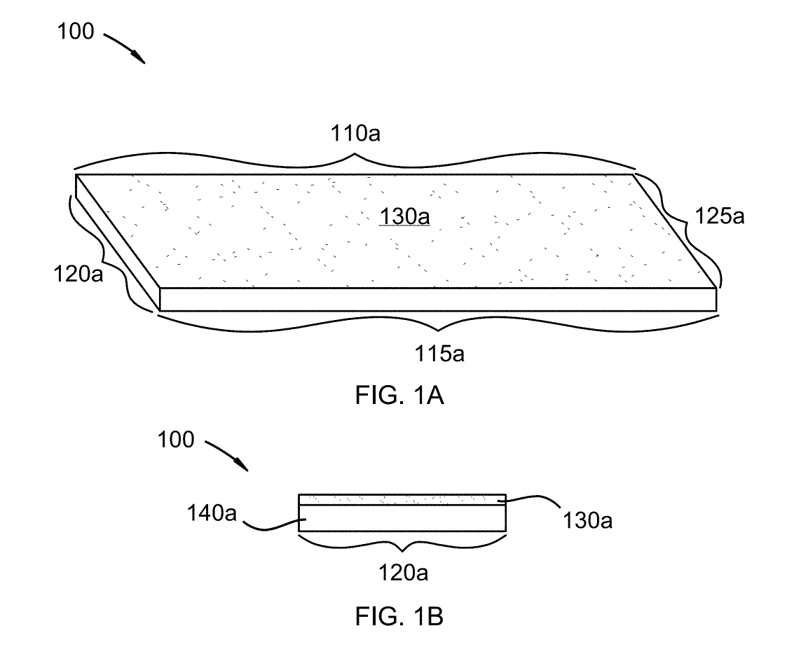

Referring now to the drawings, FIG. 1A shows slat 100 which is an embodiment of a slat which may be included in the disclosed window blind. Slat 100 includes two longitudinal edges, 110a and 115a, and two transverse edges, 120a and 125a. The top surface of slat 100 is covered with metamaterial film 130a.

FIG. 1B illustrates a view from transverse edge 120a of slat 100. Transverse edge 120a is indicated as well as slat material 140a which may be a thermally non-conductive material. In some embodiments, the slat may have a top and a bottom surface made of thermally non-conductive material with a different material between the top and bottom surfaces. Metamaterial film 130a is shown covering the top surface of slat 100.

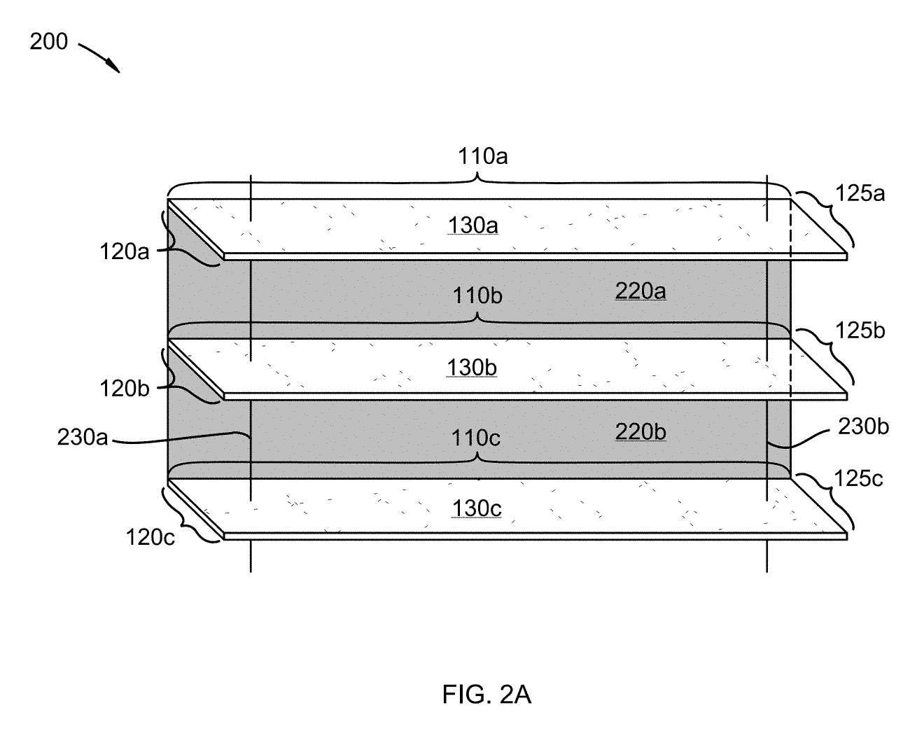

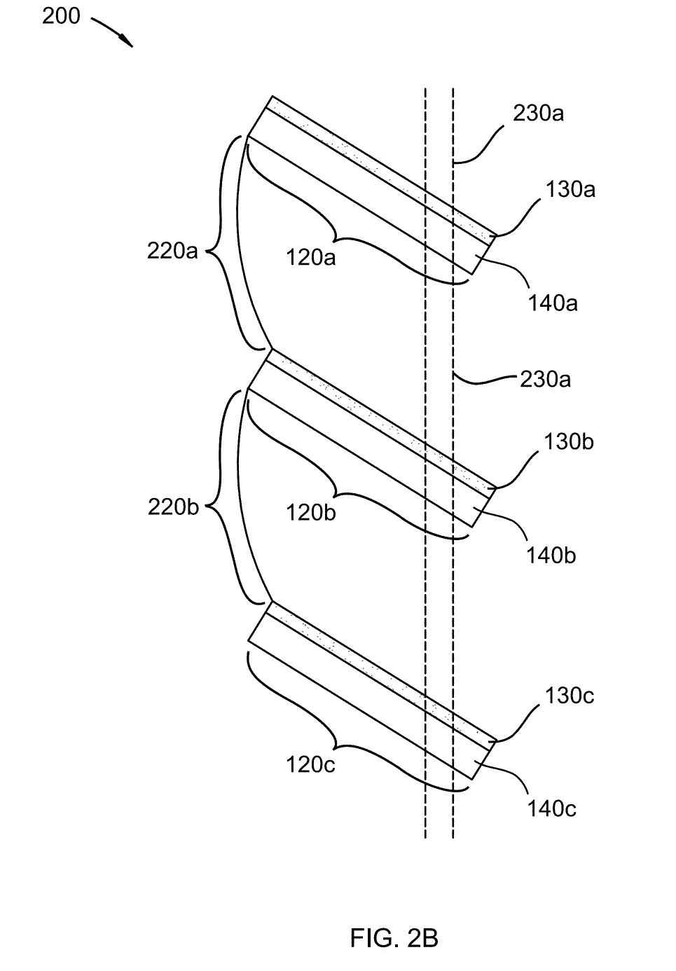

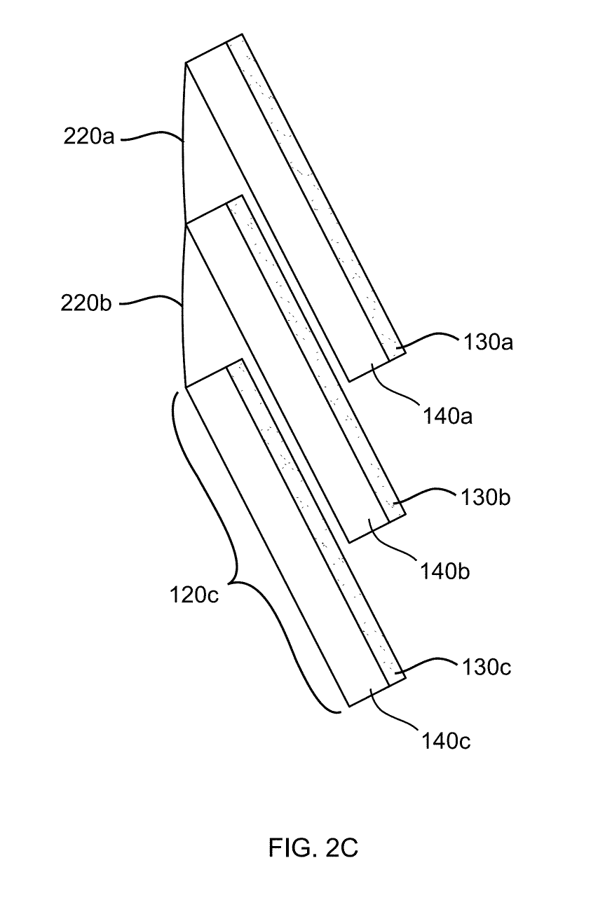

FIG. 2A illustrates window blind 200 which is an embodiment of the disclosed window blind and which includes slat 100 of FIGS. 1A and 1B as the top slat. For simplicity, only three slats are shown and the headrail is not shown. Each slat has a back longitudinal edge 110a, 110b, and 110c respectively along the rear edge of each slat. Each slat has a left transverse edge 120a, 120b, and 120c of the top, middle, and bottom slat respectively and a right transverse edge 125a, 125b, and 125c of the top, middle, and bottom slat respectively. The top surface of the top, middle, and bottom slat is covered with sections of metamaterial film 130a, 130b, and 130c respectively as shown by the speckled shading. Two sheets of infrared reflective optical interference film, 220a and 220b, are attached to back longitudinal edges 110a, 110b, and 110c of the three slats. Specifically, infrared reflective optical interference film 220a is attached to longitudinal edges 110a and 110b of the top and middle slats and stretches between the two slats. Similarly, optical interference film 220b is attached to longitudinal edges 110b and 110c of the middle and bottom slats and stretches between the two slats.

As with traditional blinds, the slats of window blind 200 may be opened and closed using tilt strings 230a and 230b. Window blind 200 is shown in FIG. 2A with the slats open. The infrared reflective optical interference films 220a and 220b are substantially transparent to light in the visible spectrum. Therefore, light may enter an adjacent room when the slats are in an open position as shown in FIG. 2A while the infrared reflective optical interference films 220a and 220b reflect infrared wavelengths.

FIG. 2B is a view from the transverse edge of window blind 200 first presented in FIG. 2A. The view is shown from transverse edges 120a, 120b, and 120c of the top, middle, and bottom slats respectively. Sections of metamaterial film 130a, 130b, and 130c are shown attached to slat material 140a, 140b, and 140c respectively. The two sections of infrared reflective optical interference film 220a and 220b are shown attached to the back longitudinal edges of the three slats.

FIG. 2C illustrates the three slats from window blind 200 from the same view as shown in FIG. 2B with the slats in a closed position. The tilt string, which may have been used to close the slats, is not shown for purposes of clarity. Note that the sections of infrared reflective optical interference film 220a and 220b have less slack in FIG. 2C than shown in FIG. 2B because the distance between the back longitudinal edges of the slats is greater when the slats are in a closed position as shown in FIG. 2C than when the slats are open position as in FIG. 2B.

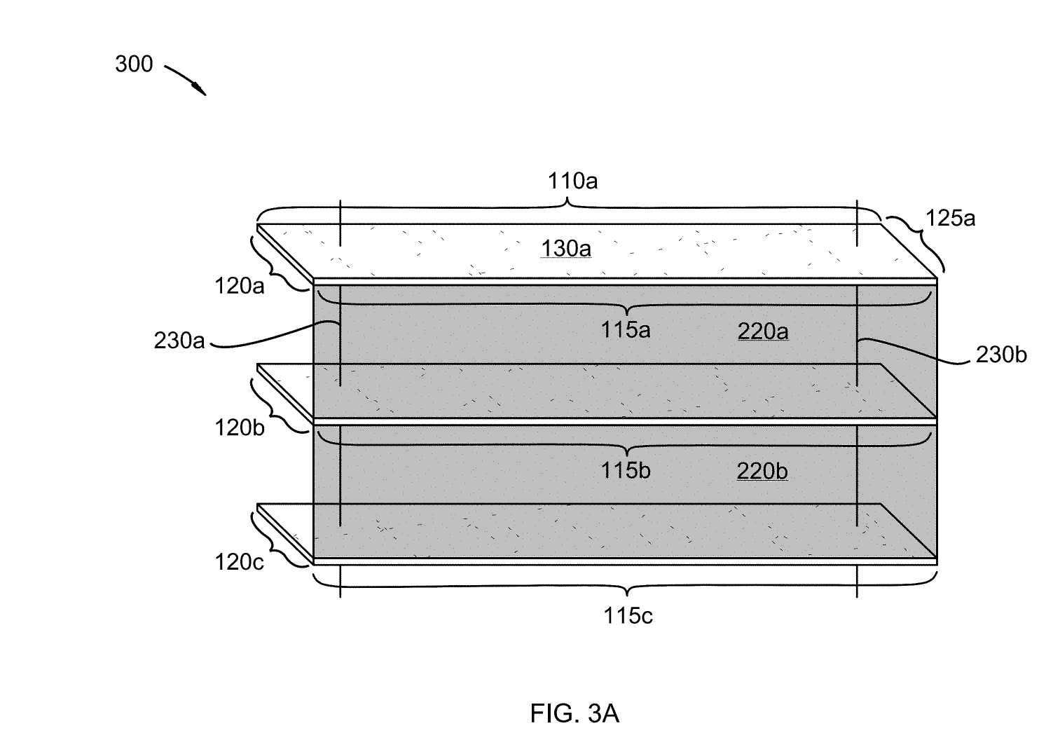

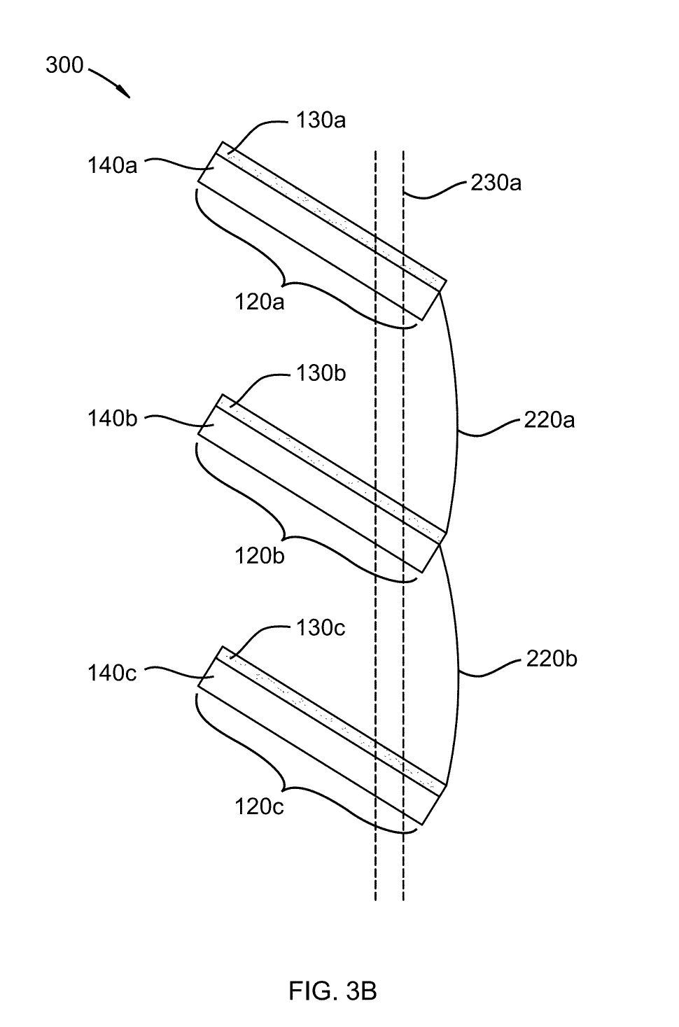

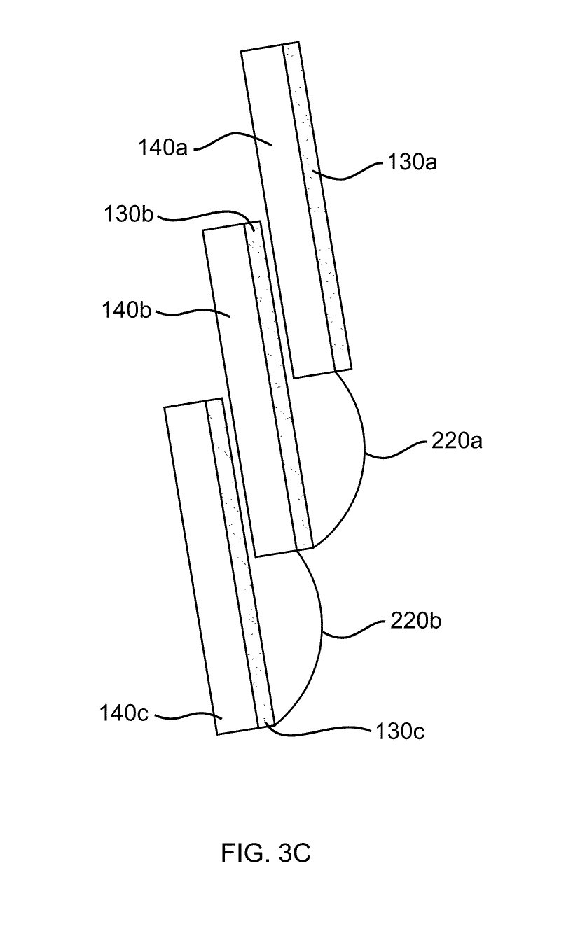

FIG. 3A illustrates window blind 300 which is another embodiment of the disclosed window blind. Similar to window blind 200 of FIG. 2A, window blind 300 includes three slats: a top, middle, and bottom slat. The headrail is not shown for purposes of clarity. The top middle and bottom slats of window blind 300 include front longitudinal edges 115a, 115b, and 115c respectively. In this embodiment, the sections of infrared reflective optical interference film 220a and 220b are attached to the front longitudinal edges of the slats. Specifically, section of infrared reflective optical interference film 220a is connected to front longitudinal edges 115a and 115b while section of infrared reflective optical interference film 220b is connected to front longitudinal edges 115b and 115c.

FIG. 3B is a view from the transverse edge of window blind 300 first presented in FIG. 3A. The view is shown from transverse edges 120a, 120b, and 120c of the top, middle, and bottom slats respectively. Sections of metamaterial film 130a, 130b, and 130c are shown attached to slat material 140a, 140b, and 140c respectively. The two sections of infrared reflective optical interference film 220a and 220b are shown attached to the front longitudinal edges of the three slats.

FIG. 3C illustrates the three slats from window blind 300 from the same view as shown in FIG. 3B with the slats in a closed position. The tilt string, which may have been used to close the slats, is not shown for purposes of clarity. Note that the sections of infrared reflective optical interference film 220a and 220b have more slack in FIG. 3C than shown in FIG. 3B because the distance between the front longitudinal edges of the slats is less when the slats are in a closed position as shown in FIG. 3C than when the slats are open position as in FIG. 3B.

While specific embodiments have been illustrated and described above, it is to be understood that the disclosure provided is not limited to the precise configuration, steps, and components disclosed. Various modifications, changes, and variations apparent to those of skill in the art may be made in the arrangement, operation, and details of the methods and systems disclosed, with the aid of the present disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that changes may be made to the details of the above-described embodiments without departing from the underlying principles of the disclosure herein.

1. A window blind comprising:
a plurality of slats, each of the plurality of slats comprising:
a front longitudinal edge;
a back longitudinal edge;
two transverse edges; and
a top surface; and
a metamaterial film, wherein the metamaterial film is attached to the top surface, and wherein the metamaterial film comprises:
a polymer, the polymer comprising silicon dioxide microspheres (SiO₂), and
a silver coating, wherein the silver coating is between the polymer and the top surface; and
at least one sheet of infrared reflective optical interference film, the at least one sheet of infrared reflective optical interference film comprising:
a first longitudinal edge and a second longitudinal edge,
wherein the at least one sheet of infrared reflective optical interference film is attached to at least one back longitudinal edge of a slat within the plurality of slats, and
wherein the infrared reflective optical interference film is substantially transparent to wavelengths of light in the visible spectrum.

2. The window blind of claim 1, wherein the at least one sheet of infrared reflective optical interference film comprises a single sheet, and wherein the single sheet is attached to the back longitudinal edge of each of the plurality of slats.

3. The window blind of claim 1, wherein the at least one sheet of infrared reflective optical interference film comprises a plurality of sheets,
wherein the plurality of sheets comprises a first sheet, the first sheet comprising a first longitudinal edge and a second longitudinal edge,
wherein the first longitudinal edge of the first sheet is attached to a back longitudinal edge of a first slat within the plurality of slats, and
wherein the second longitudinal edge of the first sheet is attached to a back longitudinal edge of a second slat within the plurality of slat.

4. The window blind of claim 1, wherein each of the plurality of slats further comprises a bottom surface; wherein the bottom surface is attached to the metamaterial film.

5. The window blind of claim 1, wherein the plurality of slats further comprises a thermally non-conductive material.

6. The window blind of claim 1, wherein the at least one sheet of infrared reflective optical interference film is substantially flexible.

7. The window blind of claim 1, wherein the infrared reflective optical interference film is removable.

8. The window blind of claim 1, wherein the metamaterial film is between about 25 and about 75 micrometers thick.

9. The window blind of claim 1, wherein the concentration of the microspheres in the polymer of the metamaterial film is between approximately 4% and approximately 8% by volume.

10. The window blind of claim 1, wherein the polymer of the metamaterial film comprises one or more of the following: polymethylpentene, poly(methyl methacrylate), and polyethylene.

11. A window blind comprising:
a plurality of slats, each of the plurality of slats comprising:
a front longitudinal edge;
a back longitudinal edge;
two transverse edges; and
a top surface; and
a metamaterial film, wherein the metamaterial film is attached to the top surface, and wherein the metamaterial film comprises:
a polymer, the polymer comprising silicon dioxide microspheres (SiO₂), and
a silver coating, wherein the silver coating is adjacent to the polymer; and
at least one sheet of infrared reflective optical interference film, the at least one sheet of infrared reflective optical interference film comprising:
a first longitudinal edge and a second longitudinal edge,
wherein the at least one sheet of infrared reflective optical interference film is attached to at least one front longitudinal edge of a slat within the plurality of slats, and
wherein the infrared reflective optical interference film is substantially transparent to wavelengths of light in the visible spectrum.

12. The window blind of claim 11, wherein the at least one sheet of infrared reflective optical interference film comprises a single sheet, and wherein the single sheet is attached to the front longitudinal edge of each of the plurality of slats.

13. The window blind of claim 11, wherein the at least one sheet of infrared reflective optical interference film comprises a plurality of sheets,
wherein the plurality of sheets comprises a first sheet,
wherein the first longitudinal edge of the first sheet is attached to a front longitudinal edge of a first slat within the plurality of slats, and
wherein the second longitudinal edge of the first sheet is attached to a front longitudinal edge of a second slat within the plurality of slats.

14. The window blind of claim 11, wherein each of the plurality of slats further comprises a bottom surface; wherein the bottom surface is attached to the metamaterial film.

15. The window blind of claim 11, wherein the the plurality of slats further comprises a thermally non-conductive material.

16. The window blind of claim 11, wherein the at least one sheet of infrared reflective optical interference film is substantially flexible.

17. The window blind of claim 1, wherein the infrared reflective optical interference film is removable.

18. The window blind of claim 11, wherein the metamaterial film is between about 25 and about 75 micrometers thick.

19. The window blind of claim 11, wherein the concentration of the microspheres in the polymer of the metamaterial film is between approximately 4% and approximately 8% by volume.

20. The window blind of claim 11, wherein the polymer of the metamaterial film comprises one or more of the following: polymethylpentene, poly(methyl methacrylate), and polyethylene.
